(19) United States
(12) Patent Application Publication
(10) Pub. No.: US 2006/0269727 A1
(43) Pub. Date: Nov. 30, 2006

(54) Decorative material

(76) Inventors: Shigeki Sugita, Tokyo (JP); Takeshi Kobayashi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/391,351

(22) Filed: Mar. 29, 2006

(30) Foreign Application Priority Data
Mar. 29, 2005 (JP) 2005-094870
Sep. 30, 2005 (JP) 2005-287580

(51) Int. Cl. G03G 7/00

(52) U.S. Cl. 428/195.1

(57) ABSTRACT

There is provided a decorative material which can exhibit a high oil resistance and is totally excellent in surface properties such as stain resistance, abrasion resistance and marring resistance. The decorative material of the present invention comprises a substrate, and a pattern layer and/or a colored layer, and a surface protective layer which are successively laminated on the substrate, wherein said substrate is constituted from an oil-resistant paper treated with a fluorine-based sizing agent which has a degree of oil resistance of 4 or more as measured by No. 41:2000 method prescribed in Japan TAPPI Paper and Pulp Testing Method, and said surface protective layer is obtained by crosslinking and curing an electron beam-curable resin composition, or comprises a substrate, and a colored layer and a surface protective layer which are successively laminated on the substrate, wherein said colored layer is made of an acrylic resin composition, and said surface protective layer is obtained by crosslinking and curing an electron beam-curable resin composition.

### BACKGROUND OF THE INVENTION

1. Field of the Invention

The present invention relates to decorative materials using an oil-resistant paper as a substrate and having a surface protective layer obtained by crosslinking and curing an electron beam-curable resin composition, or provided on the substrate with a colored layer made of an acrylic resin composition and a surface protective layer obtained by crosslinking and curing an electron beam-curable resin composition, and are excellent in surface properties such as oil resistance, stain resistance, abrasion resistance and marring resistance.

2. Description of Related Arts

Decorative materials used in the applications including building interior materials such as walls, fittings for buildings such as doors, surface materials for furniture, etc., have been usually required to exhibit good surface properties such as abrasion resistance and stain resistance. Hitherto, there has been proposed the decorative sheet having a surface resin layer, which is produced, for example, by forming a pattern layer on a substrate made of papers or plastics by a printing method, applying an ionizing radiation-curable resin coating material, unsaturated polyester prepolymer, on the substrate to form a coating resin layer, and then irradiating an electron beam to the coating resin layer for crosslinking and curing the resin to form the surface resin layer (for example, refer to Japanese Patent Publication No. 31033/1974). When such a surface resin layer obtained by irradiating an ionizing radiation such as an electron beam to the applied ionizing radiation-curable resin made of monomers, prepolymers, etc., to crosslink and cure the resin is provided as an outermost layer of a decorative sheet, the resultant decorative sheet is excellent in surface properties such as abrasion resistance and stain resistance due to a high crosslinkability thereof

On the other hand, decorative materials to be attached to an outer surface of kitchen wares, cup boards, etc., have also been required to exhibit a good oil resistance. There have been proposed oil-resistant decorative printed sheets using a thin cut sheet paper impregnated with an oil-resistant resin (for example, Japanese Patent Application Laid-open No. 118554/1996). However, these conventionally proposed oil-resistant decorative sheets fail to completely satisfy surface properties such as oil resistance. Therefore, it has been demanded to provide decorative materials exhibiting totally excellent surface properties including oil resistance, stain resistance, abrasion resistance and marring resistance.

### SUMMARY OF THE INVENTION

The present invention has been made in view of the above conventional problems. An object of the present invention is to provide a decorative material which is excellent in surface properties including not only oil resistance but also stain resistance, abrasion resistance and marring resistance.

As a result of intensive and extensive researches to achieve the above object, the inventors have found that when a specific oil-resistant paper is used as a substrate, and a surface protective layer obtained by crosslinking and curing an electron beam-curable resin composition is formed on the substrate, or a colored layer made of an acrylic resin composition and a surface protective layer obtained by crosslinking and curing an electron beam-curable resin composition are successively formed on the substrate, the resultant decorative material can exhibit excellent surface properties including not only oil resistance but also stain resistance, abrasion resistance and marring resistance. The present invention has been accomplished on the basis of the finding.

Thus, the present invention provides:

(1) A decorative material comprising a substrate, and a pattern layer and/or a colored layer, and a surface protective layer which are laminated on the substrate, wherein said substrate is constituted from an oil-resistant paper treated with a fluorine-based sizing agent which has a degree of oil resistance of 4 or more as measured by No. 41:2000 method prescribed in Japan TAPPI Paper and Pulp Testing Method, and said surface protective layer is obtained by crosslinking and curing an electron beam-curable resin composition;

(2) a decorative material comprising a substrate, and a colored layer and a surface protective layer which are laminated on the substrate, wherein said colored layer is made of an acrylic resin composition, and said surface protective layer is obtained by crosslinking and curing an electron beam-curable resin composition;

(3) the decorative material described in the above aspect (2), wherein said substrate is constituted from an oil-resistant paper treated with a fluorine-based sizing agent which has a degree of oil resistance of 4 or more as measured by No. 41:2000 method prescribed in Japan TAPPI Paper and Pulp Testing Method;

(4) the decorative material described in the above aspect (2) or (3), wherein said acrylic resin is a two-part curable system containing a polyol component.

(5) the decorative material described in any one of the above aspects (1) to (4), wherein an ink used in said pattern layer and/or colored layer contains titania;

(6) the decorative material described in any one of the above aspects (1) to (5), further comprising a primer layer containing an acrylic resin which is formed between the pattern layer and/or colored layer, and the surface protective layer; and

(7) a decorative plate comprising a base plate and the decorative material as defined in any one of aspects (1) to (6) which is laminated on the substrate.

In accordance with the present invention, there is provided a decorative material which exhibits excellent surface properties including not only oil resistance but also stain resistance, abrasion resistance and marring resistance.

### BRIEF DESCRIPTION OF THE DRAWING

FIG. 1 is a schematic view showing a section of a decorative material according to the present invention.

### EXPLANATION OF REFERENCE NUMERALS

1: Decorative material; 2: Substrate; 3: Colored layer; 4: Pattern layer; 5: Primer layer; 6: Surface protective layer

### DETAILED DESCRIPTION OF THE INVENTION

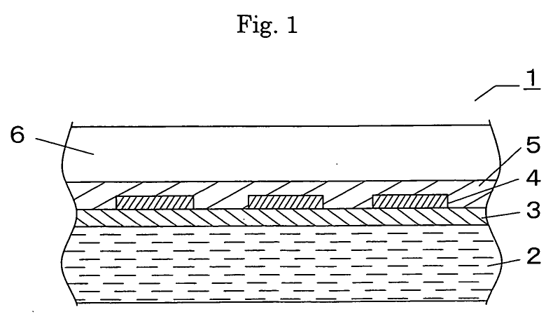

The typical structure of the decorative material according to the present invention is explained by referring to FIG. 1 which is a schematic view showing a section of a decorative material 1 of the present invention. In the embodiment shown in FIG. 1, a colored layer 3 uniformly covering a whole surface of a substrate 2, a pattern layer 4, a uniform primer layer 5 and a surface protective layer 6 obtained by crosslinking and curing an electron beam-curable resin composition are successively laminated on the substrate 2 in this order.

The decorative material of the present invention is characterized by using as a substrate thereof an oil-resistant paper treated with a fluorine-based sizing agent which has the value of 4 or more as measured by No. 41:2000 method prescribed in JAPAN TAPPI Paper and Pulp Testing Method (hereinafter referred to as “degree of oil resistance”). The degree of oil resistance of 4 or more means that the oil-resistant paper exhibits a sufficient oil resistance. In view of attaining a sufficient oil resistance, the oil-resistant paper has a degree of oil resistance of preferably 5 or more and more preferably 7 or more. The upper limit of the degree of oil resistance of the oil-resistant paper is not particularly limited, and is preferably 12 or less in view of limited conditions for production thereof

The papers used as a base material of the oil-resistant paper are not particularly limited. Examples of the papers include thin cut sheet papers, kraft papers and titanium papers. As the fluorine-based sizing agent, there may be used various compounds, for example, perfluoroalkyl acrylic esters, fluorine-based resins, etc., though not particularly limited thereto. As the method of treating these papers with the fluorine-based sizing agent, there may be used either the method of impregnating the paper base material with the sizing agent after paper-making, or the method of incorporating the sizing agent into the paper base material during paper-making. Meanwhile, in order to prevent formation of fuzzes, these paper base materials may further contain resins such as acrylic resins, styrene-butadiene rubbers, melamine resins and urethane resins.

In addition, the substrate 2 may be treated for forming a primer layer thereon, may be painted to control a color tone thereof, or may be previously provided thereon with a pattern in view of a good design property thereof.

The thickness of the substrate 2 is not particularly limited. The basis weight of the substrate is usually about 20 to 150 g/m² and preferably 30 to 100 g/m².

Also, the decorative material of the present invention is characterized by providing thereon with the colored layer 3 which is formed so as to cover a whole surface of the substrate as shown in FIG. 1, and made of an acrylic resin composition. The colored layer 3 is usually provided in order to enhance a design property of the decorative material, and may also be referred to as a concealing layer or a whole surface solid layer. Thus, the colored layer 3 serves for coloring the surface of the substrate 2 as intended. In the present invention, the colored layer is also important to impart a good oil resistance to the decorative material. The colored layer usually has an opaque color in many cases, but may also show a tinted transparent color to utilize an original pattern of the underlying layer. Alternatively, when utilizing a white color of the substrate 2, the layer 3 may be a colorless transparent layer.

Also, the feature of the present invention resides in that the colored layer is made of an acrylic resin composition, i.e., an ink for forming the colored layer contains an acrylic resin as a binder thereof. Examples of the acrylic resin include polymethyl(meth)acrylate, polyethyl(meth)acrylate, polybutyl(meth)acrylate, methyl(meth)acrylate-butyl (meth)acrylate copolymers, ethyl(meth)acrylate-butyl(meth)acrylate copolymers and methyl(meth)acrylate-styrene copolymers. Meanwhile, the term “(meth)acrylate” used herein means both an acrylate and a methacrylate. Further, in order to enhance the oil resistance, the colored layer containing these acrylic resins may be suitably subjected to surface treatment to render the resins hydrophilic. These acrylic resins may be used alone or in the form of a mixture of any two or more thereof.

In addition, the above acrylic resin is preferably a two-part curable-type acrylic resin containing a polyol component for enhancing the oil resistance. The two-part curable-type acrylic resin is mainly composed of an acrylic resin into a molecule of which usually 2 or more reactive functional groups of at least one kind such as a hydroxyl group and a carboxyl group are introduced. For example, the acrylic resin into which 2 or more hydroxyl groups as the reactive functional groups are introduced are referred to as an acrylic polyol. Examples of the hydroxyl-containing acrylic resin include copolymers obtained by copolymerizing at least one (meth)acrylic alkyl ester monomer such as methyl (meth)acrylate, ethyl (meth)acrylate, n-propyl (meth)acrylate, isopropyl (meth)acrylate, n-butyl (meth)acrylate, isobutyl (meth)acrylate, octyl (meth)acrylate and ethylhexyl (meth)acrylate, at least one (meth)acrylic ester monomer containing a hydroxyl group in a molecule thereof such as 2-hydroxyethyl (meth)acrylate, 2-hydroxypropyl (meth)acrylate and 2-hydroxy-3-phenoxypropyl (meth)acrylate and, if required, the other vinyl monomer such as a styrene monomer, with each other.

Also, as the carboxyl-containing acrylic resin, there may be used copolymers obtained by copolymerizing carboxyl-containing vinyl monomers, etc.

Meanwhile, the term “(meth)acrylic acid” used herein means acrylic acid, methacrylic acid or both thereof.

As the isocyanate as the curing agent, there may be suitably used polyvalent isocyanates having 2 or more isocyanate groups in a molecule thereof. Examples of the isocyanates include aromatic isocyanates such as 2,4-tolylene diisocyanate, xylylene diisocyanate and 4,4-diphenylmethane diisocyanate, and aliphatic isocyanates such as hexamethylene diisocyanate, isophorone diisocyanate, hydrogenated tolylene diisocyanate and hydrogenated diphenylmethane diisocyanate.

Further, the above acrylic resin composition may also contain titania in order to allow the composition to exhibit a good hiding power. In particular, the titania added to the composition preferably has an oil absorption of 17 to 36 g/100 g as measured according to JIS K5101 using a linseed oil. Although the acrylic resin composition containing titania is lowered in its oil resistance, when the oil absorption of titania added lies within the above-specified range, the titania-containing composition can exhibit a good hiding power without significant decrease in oil resistance. From the above viewpoints, the oil absorption of the titania added is more preferably from 17 to 22 g/100 g.

Further, in order to impart an especially high oil resistance to the acrylic resin composition, the oil absorption of the titania added thereto is preferably as low as possible, more specifically, is 20 g/100 g or less as measured according to JIS K5101 using a linseed oil.

The content of the titania in the acrylic resin composition is preferably within the range of 40 to 85% by mass as measured in a dried state. When the content of the titania in the composition is 40% by mass or more, the resultant composition can exhibit a sufficient hiding power, whereas when the content of the titania in the composition is 85% by mass or less, the resultant composition can show a sufficient strength as well as a good printability when formed into a coating layer. From the above viewpoints, the content of the titania in the acrylic resin composition is more preferably in the range of 50 to 80% by mass.

In the present invention, as described above, when the oil-resistant paper treated with the fluorine-based sizing agent which has a degree of oil resistance of 4 or more is used as the substrate or when the colored layer is made of the acrylic resin composition, the aimed effects of the present invention can be suitably exhibited. Further, when both the oil-resistant paper substrate treated with the fluorine-based sizing agent which has a degree of oil resistance of 4 or more and the colored layer constituted of the acrylic resin composition are used, the resultant decorative material can be further enhanced in oil resistance and can exhibit excellent surface properties.

Meanwhile, in the case where the oil-resistant paper treated with the fluorine-based sizing agent which has a degree of oil resistance of 4 or more is used as the substrate, it is not necessarily required to provide the colored layer made of the acrylic resin composition. In such a case, the colored layer may be composed of the other resins than the acrylic resin composition. Specific examples of the other resins include polyurethane-based resins, vinyl chloride/vinyl acetate-based copolymer resins, vinyl chloride/vinyl acetate/acrylic copolymer resins, chlorinated polypropylene-based resins, polyester-based resins, polyamide-based resins, butyral-based resins, polystyrene-based resins, nitrocellulose-based resins and cellulose acetate-based resins. Among these resins, the hydrophilic resins are preferred in view of attaining a sufficient oil resistance. Further, the above other resins may be suitably surface-treated to render these resins hydrophilic. These other resins may be used alone or in the form of a mixture of any two or more thereof

The ink used for forming the colored layer may be produced by appropriately mixing the above binder with a colorant such as pigments and dyes, an extender pigment, a solvent, a stabilizer, a plasticizer, a catalyst, a hardening agent, etc.

Examples of the colorant used in the colored layer include inorganic pigments such as carbon black (Japanese ink), iron black, titanium white, antimony white, chrome yellow, titanium yellow, iron oxide red, cadmium red, ultramarine blue and cobalt blue; organic pigments and dyes such as quinacridone red, isoindolinone yellow and phthalocyanine blue; metallic pigments made of scale-like foil pieces of aluminum, brass, etc., and nacreous (pearl) pigments made of scale-like foil pieces of titanium dioxide-coated mica, basic lead carbonate, etc.

The suitable thickness of the colored layer 3 varies depending upon the kind of substrate 2 used. When an ordinary paper is used as the substrate, the thickness of the colored layer 3 is preferably from 10 to 25 μm. Once an oil component reaches the ordinary paper substrate, the oil is rapidly spread thereover. Therefore, in such a case, it is important to prevent the oil component from reaching the substrate 2 by providing the colored layer having an adequate thickness. When the thickness of the colored layer 3 is 10 μm or more, the oil component can be prevented from penetrating therethrough and reaching the substrate 2, thereby ensuring sufficient oil resistance and hiding power of the resultant decorative material. On the other hand, when the thickness of the colored layer 3 is 25 μm or less, the resultant decorative material is advantageous from the viewpoints of printability, design property, production costs and processability.

When the so-called oil-resistant paper is used as the substrate 2, the thickness of the colored layer is not particularly limited since the substrate itself exhibits an adequate oil resistance. In such a case, the colored layer 3 may be suitably constituted of a so-called solid printing layer having a thickness of usually about 1 to 20 μm.

The pattern layer 4 shown in FIG. 1 serves for imparting a decorative design to the substrate 2, and is formed by printing various patterns with an ink using a printer. Examples of the patterns formed by the pattern layer include woodgrain patterns, stone-grain patterns imitating the surface of rocks such as marble pattern (e.g., travertine marble pattern), cloth patterns imitating texture of cloth and fabric, tiling patterns, brick work patterns, and composite patterns thereof such as parquetry patterns and patchwork patterns. These patterns may be usually produced by multi-color printing with a process color including yellow, red, blue and black colors, or by multi-color printing with a special color using printing plates corresponding to individual colors of the pattern. The pattern ink used for forming the pattern layer 4 may be the same as the ink used for forming the colored layer 3.

The ink used for forming the pattern layer 4 may also contain the same titania as used in the colored layer 3. When the titania is added to the pattern layer, the resultant decorative material can be further enhanced in oil resistance.

The primer layer 5 shown in FIG. 1 may be optionally provided on the substrate 2 according to requirements. In the case where the colored layer 3, the pattern layer 4, etc., are formed on the substrate 2, the primer layer has a function for smoothening the surface of the respective layers and enhancing an adhesion of these layers to the surface protective layer 6. As the material of the primer layer 5, there may be usually used polyurethane-based resins, polyester-based resins, polyamide-based resins and butyral-based resins. In the decorative material of the present invention, the primer layer is preferably composed of acrylic resins. When the substrate is provided with such a primer layer composed of acrylic resins, the resultant decorative material can be further enhanced in oil resistance.

Meanwhile, the primer layer 5 also has a function of inhibiting penetration of an ionizing radiation-curable resin for forming the surface protective layer 6 into the substrate 2.

The surface protective layer 6 is formed by crosslinking and curing the electron beam-curable resin composition as described above. The electron beam-curable resin composition used herein means a resin composition capable of undergoing crosslinking and curing reactions upon irradiating an electron beam thereto. More specifically, the electron beam-curable resin composition usable in the present invention may be appropriately selected from polymerizable monomers and polymerizable oligomers or prepolymers thereof which are conventionally used as an electron beam-curable resin composition.

Typical examples of the suitable polymerizable monomers include (meth)acrylate-based monomers containing a radical-polymerizable unsaturated group in a molecule thereof. Among these (meth)acrylate-based monomers, preferred are polyfunctional (meth)acrylates. Meanwhile, the term “(meth)acrylate” used herein means an acrylate, a methacrylate or both thereof. The polyfunctional (meth)acrylates are not particularly limited as long as they have two or more ethylenically unsaturated bonds in a molecule thereof. Specific examples of the polyfunctional (meth)acrylates include ethylene glycol di(meth)acrylate, propylene glycol di(meth)acrylate, 1,4-butanediol di(meth)acrylate, 1,6-hexanediol di(meth)acrylate, neopentyl glycol di(meth)acrylate, polyethylene glycol di(meth)acrylate, neopentyl glycol di(meth)acrylate hydroxypivalate, dicyclopentenyl di(meth)acrylate, caprolactone-modified dicyclopentenyl di(meth)acrylate, ethyleneoxide-modified phosphoric acid di(meth)acrylate, allylated cyclohexyl di(meth)acrylate, isocyanurate di(meth)acrylate, trimethylolpropane tri(meth)acrylate, ethyleneoxide-modified trimethylolpropane tri(meth)acrylate, dipentaerythritol tri(meth)acrylate, propionic acid-modified dipentaerythritol tri(meth)acrylate, pentaerythritol tri(meth)acrylate, propyleneoxide-modified trimethylolpropane tri(meth)acrylate, tris(acryloxyethyl) isocyanurate, propionic acid-modified dipentaerythritol penta(meth)acrylate, dipentaerythritol hexa(meth)acrylate, ethyleneoxide-modified dipentaerythritol hexa(meth)acrylate and caprolactone-modified dipentaerythritol hexa(meth)acrylate. These polyfunctional (meth)acrylates may be used alone or in combination of any two or more thereof.

In the present invention, for the purposes of reducing a viscosity of the polyfunctional (meth)acrylate, etc., a monofunctional (meth)acrylate may be appropriately used in combination with the polyfunctional (meth)acrylate unless the effects of the present invention are adversely affected. Examples of the monofunctional (meth)acrylate include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, lauryl (meth)acrylate, stearyl (meth)acrylate and isobornyl (meth)acrylate. These monofunctional (meth)acrylates may be used alone or in combination of any two or more thereof.

As the polymerizable oligomer, there may be used oligomers having a radical-polymerizable unsaturated group in a molecule thereof. Examples of the polymerizable oligomers include epoxy (meth)acrylate-based oligomers, urethane (meth)acrylate-based oligomers, polyester (meth)acrylate-based oligomers and polyether (meth)acrylate-based oligomers. The epoxy (meth)acrylate-based oligomers may be produced, for example, by esterifying an oxirane ring of a relatively low-molecular weight bisphenol-type epoxy resin or novolak-type epoxy resin with (meth)acrylic acid. In addition, there may also be used carboxyl-modified epoxy (meth)acrylate oligomers obtained by partially modifying the above epoxy (meth)acrylate-based oligomers with a dibasic carboxylic anhydride. The urethane (meth)acrylate-based oligomers may be produced, for example, by esterifying a polyurethane oligomer obtained by reacting a polyether polyol or a polyester polyol with polyisocyanate, with (meth)acrylic acid. The polyester (meth)acrylate-based oligomers may be produced, for example, by esterifying a hydroxyl group of a polyester oligomer having hydroxyl groups at both terminal ends thereof which is obtained by condensation between a polycarboxylic acid and a polyhydric alcohol, with (meth)acrylic acid, or by esterifying a terminal hydroxyl group of an oligomer obtained by adding an alkyleneoxide to a polycarboxylic acid, with (meth)acrylic acid. The polyether (meth)acrylate-based oligomers may be produced, for example, by esterifying a hydroxyl group of a polyether polyol with (meth)acrylic acid.

Examples of the other polymerizable oligomers include polybutadiene (meth)acrylate-based oligomers having a high hydrophobic property which is in the form of a polybutadiene oligomer having a (meth)acrylate group in a side chain thereof; silicone (meth)acrylate-based oligomers having a polysiloxane bond in a main chain thereof; aminoplast resin (meth)acrylate-based oligomers obtained by modifying an aminoplast resin having a large number of reactive groups in a small molecule thereof; and oligomers having a cation-polymerizable functional group in a molecule thereof such as a novolak-type epoxy resin, a bisphenol-type epoxy resin, an aliphatic vinyl ether and an aromatic vinyl ether.

The electron beam-curable resin composition used in the present invention may also contain various additives according to required properties of the obtained cured resin layer. Examples of the additives include weather resistance-improving agents, abrasion resistance-improving agents, polymerization inhibitors, crosslinking agents, infrared-absorbing agents, antistatic agents, adhesion-improving agents, leveling agents, thixotropic agents, coupling agents, plasticizers, antifoaming agents, fillers, solvents and colorants.

As the weather resistance-improving agents, there may be used ultraviolet-absorbing agents or light stabilizers. The ultraviolet absorbing agents may be either inorganic or organic compounds. As the preferred inorganic ultraviolet absorbing agents, there may be suitably used particles of titanium dioxide, cerium oxide or zinc oxide which have an average particle size of about 5 to 120 nm. As the organic ultraviolet absorbing agents, there may be used benzotriazole-based compounds. Specific examples of the benzotriazole-based compounds include 2-(2-hdyroxy-5-methylphenyl)benzotriazole, 2-(2-hydroxy-3,5-di-tert-amylphenyl)benzotriazole and polyethylene glycol 3-[3-(benzotriazol-2-yl)-5-tert-butyl-4-hydroxyphenyl]propionic ester. Also, examples of the light stabilizer include hindered amine-based compounds. Specific examples of the hindered amine-based compounds include bis(1,2,2,6, 6-pentamethyl-4-piperizyl) 2-(3, 5-di-tert-butyl-4-hydroxybenzyl)-2′-n-butyl malonate, bis(1,2,2,6,6-pentamethyl-4-piperidyl) sebacate and tetrakis(2,2,6, 6-tetramethyl-4-piperidyl)-1,2,3,4-butanetetracarboxylate. In addition, as the ultraviolet absorbing agent or the light stabilizer, there may also be used reactive ultraviolet absorbing agents or light stabilizers having a polymerizable group such as a (meth)acryloyl group in a molecule thereof

Examples of the inorganic abrasion resistance-improving agent include generally spherical particles of α-alumina, silica, kaolinite, iron oxide, diamond and silicon carbide. The shape of the inorganic abrasion resistance-improving agent may be a spherical shape, an ellipsoidal shape, a polyhedral shape or a scale-like shape. Among these shapes, preferred is the spherical shape although not particularly limited thereto. Examples of the organic abrasion resistance-improving agent include beads of synthetic resins such as crosslinked acrylic resins and polycarbonate resins. The particle size of the abrasion resistance-improving agent may be usually about 30 to 200% of a thickness of the cure resin layer. Among these abrasion resistance-improving agents, spherical α-alumina particles are especially preferred because of high hardness, large effect of improving the abrasion resistance and relatively easy production of the spherical particles.

Examples of the polymerization inhibitor include hydroquinone, p-benzoquinone, hydroquinone monomethyl ether, pyrogallol and t-butyl catechol. Examples of the crosslinking agent used in the present invention include polyisocyanate compounds, epoxy compounds, metal chelate compounds, aziridine compounds and oxazoline compounds.

Examples of the filler include barium sulfate, talc, clay, calcium carbonate and aluminum hydroxide.

Examples of the colorant include known coloring pigments such as quinacridon red, isoindolinone yellow, phthalocyanine blue, phthalocyanine green, titanium oxide and carbon black.

Examples of the infrared-absorbing agent include dithiol-based metal complexes, phthalocyanine-based compounds and diimmonium compounds.

In the present invention, the above polymerizable monomers or polymerizable oligomers as the electron beam-curable component and various additives are intimately mixed with each other at a given mixing ratio to prepare a coating solution composed of the electron beam-curable resin composition. The viscosity of the coating solution is not particularly limited as long as the coating solution can be formed into an uncured resin layer on a surface of the substrate by the below-mentioned coating methods.

In the present invention, the thus prepared coating solution is applied onto a surface of the substrate in an amount capable of providing a cured coating layer having a thickness of 1 to 20 μm, by known methods such as gravure coating, bar coating, roll coating, reverse roll coating and Komma coating, preferably gravure coating, thereby forming an uncured resin layer thereon. The cured coating layer having a thickness of 1 μm or larger can exhibit good functions as required. The thickness of the cured surface protective layer is preferably about 2 to 20 μm.

The coating solution used in the present invention which is composed of the electron beam-curable resin composition can be applied without using any solvent and, therefore, is free from generation of air bubbles upon curing by irradiation with an electron beam, so that the resultant surface protective layer can be enhanced in oil resistance as compared to the conventional surface protective layers composed of urethane resins, etc.

The thus formed uncured resin layer is then cured by irradiating an electron beam thereto. The acceleration voltage for the electron beam may be appropriately determined according to the kind of resin used and the thickness of the resin layer. The uncured resin layer is preferably cured by irradiating an electron beam thereto at an acceleration voltage of usually about 70 to 300 kV.

Meanwhile, upon irradiation of the electron beam, the higher acceleration voltage leads to increase in penetrability of the electron beam. Therefore, when using a substrate which tends to be deteriorated by exposure to the electron beam, the acceleration voltage may be controlled such that the depth of penetration of the electron beam is substantially identical to the thickness of the resin layer, thereby inhibiting an excessive amount of the electron beam from being irradiated to the substrate and minimizing deterioration of the substrate owing to irradiation with an excessive amount of the electron beam.

The exposure dose of the electron beam is preferably such an amount capable of saturating a crosslinking density of the resin layer, and may be selected from the range of usually 5 to 300 kGy, preferably 10 to 100 kGy and more preferably 30 to 70 kGy.

The electron beam source is not particularly limited. Examples of the electron beam source usable in the present invention include various electron beam accelerators such as Cockroft-Walton type, van de Graaff type, resonance transformer type, insulating core transformer type, linear type, Dynamitron type and high-frequency type.

The thus formed cured resin layer may also contain various additives to impart various functions or performances thereto. Examples of the various functions imparted by addition of the additives include functions of so-called hard coat capable of attaining a high hardness and a good marring resistance, anti-fogging coat, anti-fouling coat, anti-glare coat, anti-reflecting coat, ultraviolet-shielding coat and infrared-shielding coat.

The decorative material of the present invention can be used as a decorative plate by attaching to various substrates. The substrate as an adherend for the decorative material is not particularly limited, and may be appropriately selected from plastic sheets, metal plates, wood plates such as timber, and ceramic materials according to the applications. One or both surfaces of these substrates, in particular, plastic sheet substrates, may be optionally subjected to various physical and chemical surface treatments such as those treatments using oxidation method and convex/concave forming method in order to enhance adhesion of the substrate to the decorative material.

Examples of the treatments using the oxidation method include corona discharge treatment, chromate treatment, flame treatment, hot air treatment and ozone/ultraviolet treatment. Examples of the convex/concave forming method include a sandblast method and a solvent-treating method. The surface treatment to be conducted may be appropriately selected according to the kind of substrate used, and in general, the corona discharge treatment is preferably used because of good effects and facilitated operation thereof.

The plastic sheets may be made of various synthetic resins. Examples of the synthetic resins include polyethylene resins, polypropylene resins, polymethylpentene resins, polyvinyl chloride resins, polyvinylidene chloride resins, polyvinyl alcohol resins, vinyl chloride/vinyl acetate copolymer resins, ethylene/vinyl acetate copolymer resins, ethylene/vinyl alcohol copolymer resins, polyethylene terephthalate resins, polybutylene terephthalate resins, polyethylene naphthalate/isophthalate copolymer resins, polymethyl methacrylate resins, polyethyl methacrylate resins, polybutyl acrylate resins, polyamide resins such as typically nylon 6 and nylon 66, cellulose triacetate resins, cellophane, polystyrene resins, polycarbonate resins, polyallylate resins and polyimide resins.

Examples of the metal plates include those plates made of aluminum, iron, stainless steel, copper, etc. In addition, there may also be used those substrates which are plated with these metals.

Examples of the wood plates include sliced veneers, veneers, plywood, particle boards and medium-density fiber (MDF) boards which are made of various materials such as Japanese cryptomeria, hinoki cypress, keyaki, pine, lauan, teak and Melapi. These wood plates may be used alone or in the form of a laminate of any two or more thereof. Meanwhile, the wood plates used herein involve not only plates made of wooden materials, but also plastic plates containing paper powder and reinforced high-strength papers.

Examples of the ceramic materials include ceramic-based building materials such as gypsum boards, calcium silicate boards and wood chip cement boards, pottery, glass, porcelain enamels, baked tiles and boards made of volcanic ash as a main raw material.

In addition to the above illustrated substrates, there may also be used composite plates of various materials such as a fiber-reinforced plastic (FRP) plate, a plate produced by attaching an iron plate onto both surfaces of a paper honeycomb and a polyethylene resin sheet sandwiched between two aluminum plates.

The substrate may be subjected to further treatments for forming a primer layer thereon, adjusting a hue thereof by painting, or previously providing a pattern thereon in view of a good design property thereof. The substrate used as an adherend for the decorative material may be a plate material such as a flat plate or a curved plate made of various materials, or a three-dimensional product (molded article) in which the materials are used singly or in the form of a composite thereof.

The decorative material may be attached with a backing or lining material such as Japanese papers, machine-made papers, synthetic papers, nonwoven fabrics, woven fabrics, cheese cloths, impregnated papers and synthetic resin sheets. By attaching such a backing or lining material to the decorative material, the obtained decorative material can be reinforced by itself, and can be effectively prevented from suffering from occurrence of cracks or rapture and bleed-out of adhesives onto a surface thereof, resulting in reduction of defectives and facilitated handling procedure as well as increased yield.

The substrate on which the decorative material in the form of a cut sheet or a continuous sheet is placed through an adhesive is then pressed or compressed using a laminating apparatus such as a cold press, a hot press, a roll press, a laminator, a wrapping machine, a edge-bonding machine and a vacuum press to allow the decorative material to adhere onto a surface of the substrate, thereby producing a decorative plate.

The adhesive may be applied using a coating apparatus such as a spray coater, a spreader and a bar coater. Examples of the adhesive include vinyl acetate resin-based adhesives, urea resin-based adhesives, melamine resin-based adhesives, phenol resin-based adhesives and isocyanate-based adhesives. These adhesives may be used alone or in the form of a mixed adhesive obtained by mixing any two or more thereof with each other at an optional mixing ratio. The adhesive may contain, if required, inorganic powder such as talc, calcium carbonate, clay and titanium white, wheat flour, wood powder, plastic powder, colorants, insecticides, mildew-proof agents, etc. In general, the adhesive has a solid content of 35 to 80% by mass, and is applied onto the surface of the substrate in a coating amount of 50 to 300 g/m².

The decorative material may be usually attached onto the substrate by forming an adhesive layer on a back surface of the decorative material of the present invention and then bonding the substrate onto the adhesive layer, or by applying an adhesive onto the substrate and then bonding the decorative material onto the substrate through the adhesive.

The thus produced decorative plate may be cut into an optional size, and then the surface or butt end portion thereof may be subjected to optional decorating processes such as grooving and chamfering by means of a cutting machine such as a router and a cutter. The resultant decorative plate may be used in various applications, e.g., interior or exterior materials for buildings such as walls, ceilings and floors; surface decorative plates for fittings such as window frames, doors, balustrades, baseboards, verandahs and malls as well as surface decorative plates for kitchen wares, furniture, light-electrical appliances or OA devices, interior and exterior materials for vehicles, etc.

### EXAMPLES

The present invention will be described in more detail by referring to the following examples. However, it should be noted that these examples are only illustrative and not intended to limit the invention thereto.

(Evaluation Methods)

(1) Oil Resistance

A filter paper was fully impregnated with a salad oil, placed on a surface of the respective decorative materials obtained in the following Examples and Comparative Examples, and allowed to stand at room temperature for 24 h. Then, after the filter paper is removed from the respective decorative materials, the surface of the decorative materials was washed with a neutral detergent to remove the residual salad oil therefrom, and then observed by naked eyes to examine a degree of attachment of the residual contaminant according to JIS K6902 (filter paper method). Separately, the salad oil was directly dropped on the surface of the respective decorative materials and allowed to stand at room temperature for 24 h, and then the decorative materials were treated and observed in the same manner as in the above filter paper method (direct dropping method). The results were evaluated according to the following criteria:

A: No contaminants remained

B: Slight amount of contaminants remained, but within practically acceptable level

C: Spot-like contaminants remained and observed by naked eyes, but not diffused

D: Considerable amount of contaminants remained and diffused over a whole surface of paper

(2) Stain Resistance 1

According to JIS K-6902, contaminants were applied onto a surface of the decorative material, and then wiped off. The surface of the decorative material was observed by naked eyes to determine the extent of any residual contaminants remaining thereon. The results were evaluated according to the following criteria. Meanwhile, as the contaminants, there were used commercially available business blue ink, black marking ink and red crayon chalk.

A: No contaminants remained

B: Slight amount of contaminants remained, but within practically acceptable level

C: Considerable amount of contaminants remained

(3) Stain Resistance 2

According to JAS A staining test, contaminants were applied onto a surface of the decorative material, and after 4 h, the surface of the decorative material was wiped off with alcohol. The surface of the decorative material was observed by naked eyes to determine the extent of any residual contaminants remaining thereon. The results were evaluated according to the following criteria. Meanwhile, as the contaminants, there were used commercially available business blue ink, black marking ink and red crayon chalk.

A: No contaminants remained

B: Slight amount of contaminants remained, but within practically acceptable level

C: Considerable amount of contaminants remained

(4) Abrasion Resistance

The decorative material was subjected to JAS Abrasion C Test or JAS Abrasion A Test. Namely, the surface of the decorative material was rubbed with a truck wheel “CS-17” 200 times under a total load of 1000 gf, and then observed to determine a residual percentage of patterns thereon.

(5) Marring Resistance

Steel wool (#0000) was fitted to a weight adjusted to a load of 29.4 kPa (300 g/cm²), and the surface of the decorative material was rubbed with the steel wool 10 times. The rubbed surface portion of the decorative material was observed by naked eyes to determine the change in gloss, and the results were evaluated according to the following criteria:

A: No change in gloss occurred

B: Slight change in gloss occurred, but within practically acceptable level

C: Severe change in gloss occurred

### Example 1

Using an oil-resistant paper having a basis weight of 30 g/m² and a degree of oil resistance of 7 to 8 as the substrate 2, a whole solid printing layer having a coating amount of 18 g/m² was formed on one surface of the substrate with an urethane-based ink containing an acrylic resin a binder by a gravure printing method, thereby forming a colored layer 3. Then, a primer layer 5 was formed on the colored layer 3 using an acrylic ink.

Next, an electron beam-curable resin composition composed of 60 parts by mass of ethyleneoxide-modified trimethylolpropane ethyleneoxide triacrylate as a trifunctional acrylate monomer, 40 parts by mass of dipentaerythritol hexaacrylate as a hexafunctional acrylate monomer, 2 parts by mass of silica particles having an average particle size of 5 μm and 1 part by mass of a silicone acrylate prepolymer was applied in a coating amount of 5 g/m² on the primer layer 5 by a gravure offset coater method. After coating, an electron beam was irradiated to the thus applied electron beam-curable resin composition at an acceleration voltage of 175 kV and an exposure dose of 30 kGy (3 Mrad) to cure the composition, thereby forming a surface protective layer 6. Then, the resultant laminate was cured at 70° C. for 24 h, thereby obtaining a decorative material. The thus obtained decorative material was examined to evaluate the above properties. The results are shown in Table 1.

### Comparative Example 1

The same procedure as in Example 1 was repeated except for using an interlaminar-reinforced paper for building materials having a basis weight of 30 g/m² as the substrate 2, thereby obtaining a decorative material. The thus obtained decorative material was examined to evaluate the above properties. The results are shown in Table 1.

TABLE 1

| | | | Comparative |
|---|---|---|---|
| | | Example 1 | Example 1 |
| Oil resistance | Filter paper | A | D |
| | method | | |
| | Direct dropping | A | D |
| | method | | |
| Stain resistance 1 | Commercially | A | A |
| | available business | | |
| | blue ink | | |
| | Black marking ink | A | A |
| | Red crayon chalk | A | A |

| | | |
|---|---|---|
| Abrasion resistance (%) | 95 | 95 |
| Marring resistance | A | A |

### Example 2

Using an oil-resistant paper (substrate a) having a basis weight of 30 g/m² and a degree of oil resistance of 7 to 8 as the substrate 2, a whole solid printing layer having a coating amount of 18 g/m² was formed on one surface of the substrate with an ink (ink composition c) containing a water-based acrylic resin as a binder and 29% by mass of titania having an oil absorption of 17 to 36 g/100 g by a gravure printing method, thereby forming a colored layer 3. Then, a primer layer 5 was formed on the colored layer 3 using an acrylic ink.

Next, an electron beam-curable resin composition composed of 60 parts by mass of ethyleneoxide-modified trimethylolpropane ethyleneoxide triacrylate as a trifunctional acrylate monomer, 40 parts by mass of dipentaerythritol hexaacrylate as a hexafunctional acrylate monomer, 2 parts by mass of silica particles having an average particle size of 5 μm and 1 part by mass of a silicone acrylate prepolymer was applied in a coating amount of 5 g/m² on the primer layer 5 by a gravure offset coater method. After coating, an electron beam was irradiated to the thus applied electron beam-curable resin composition at an acceleration voltage of 175 kV and an exposure dose of 30 kGy (3 Mrad) to cure the composition, thereby forming a surface protective layer 6. Then, the resultant laminate was cured at 70° C. for 24 h, thereby obtaining a decorative material. The thus obtained decorative material was examined to evaluate the above properties. The results are shown in Table 2.

### Examples 3 to 7 and Comparative Examples 2 to 7

The same procedure as in Example 2 was repeated except that the substrate as well as the ink composition for forming the colored layer 3 were varied as shown in Table 2, thereby obtaining decorative materials. The thus obtained decorative materials were examined to evaluate the above properties. The results are shown in Table 2.

TABLE 2

| | Comparative Examples | | | | | | Comparative Examples | | | | | |
|---|---|---|---|---|---|---|---|---|---|---|---|---|
| | 2 | 3 | 4 | 5 | 6 | 7 | 2 | 3 | 4 | 5 | 6 | 7 |
| Substrate | a*¹ | a*¹ | a*¹ | b*² | b*² | b*² | a*¹ | a*¹ | a*¹ | b*² | b*² | b*² |
| Ink composition forming a colored | c*³ | d*⁴ | e*⁵ | f*⁶ | e*⁵ | f*⁶ | g*⁷ | h*⁸ | i*⁹ | g*⁷ | h*⁸ | i*⁹ |
| layer | | | | | | | | | | | | |

| | | | | | | | | | | | | | |
|---|---|---|---|---|---|---|---|---|---|---|---|---|---|
| Oil resistance | Filter paper method | C | C | C | D | D | D | C | C | C | D | D | D |
| | Direct dropping C | C | C | D | D | D | C | C | C | D | D | D | |
| | method | | | | | | | | | | | | |
| Stain | Commercially | B | A | A | B | A | A | B | A | A | B | A | A |
| resistance 2 | available business | | | | | | | | | | | | |
| | blue ink | | | | | | | | | | | | |
| | Black marking ink | B | A | A | B | A | A | B | A | A | B | A | A |
| | Red crayon chalk | B | A | A | B | A | A | B | A | A | B | A | A |

| | | | | | | | | | | | | |
|---|---|---|---|---|---|---|---|---|---|---|---|---|
| Abrasion resistance (%) | 80 | 95 | 95 | 100 | 95 | 100 | 70 | 90 | 90 | 70 | 90 | 90 |
| Marring resistance | A | A | A | A | A | A | A | A | A | A | A | A |

Note:
*¹: Substrate a: Oil-resistant paper having a basis weight of 30 g/m² and a degree of oil resistance of 7 to 8;
*²: Substrate b: Interlaminar-reinforced paper for building materials having a basis weight of 30 g/m²
*³: Ink composition c: Ink composition containing a waterbased acrylic resin as a binder and 80% by mass of titania having an oil absorption of 17 to 36 g/100 g
*⁴: Ink composition d: Ink composition containing an acrylic polyol resin as a binder and 76% by mass of titania having an oil absorption of 17 to 36 g/100 g
*⁵: Ink composition e: Ink composition containing an acrylic polyol resin as a binder and 73% by mass of titania having an oil absorption of 17 to 36 g/100 g;
*⁶: Ink composition f: Ink composition containing an acrylic polyol resin as a binder and 78% by mass of titania having an oil absorption of 17 to 36 g/100 g;
*⁷: Ink composition g: Ink composition containing a mixture of nitrocellulose and an alkyd resin as a binder and 56% by mass of titania having an oil absorption of 17 to 36 g/100 g;
*⁸: Ink composition h: Ink composition containing a mixture of nitrocellulose, an alkyd resin and an urethane resin as a binder and 82% by mass of titania having an oil absorption of 17 to 36 g/100 g; and
*⁹: Ink composition i: Ink composition containing a mixture of nitrocellulose, an alkyd resin and an urethane resin as a binder and 79% by mass of titania having an oil absorption of 17 to 36 g/100 g.

### Reference Example 1

A particle board as a substrate having a thickness of 9 mm was bonded onto a back surface of the decorative material obtained in Example 1 through an adhesive layer formed on the particle board by applying thereto an urea-based synthetic resin adhesive “OHSHIKA RESIN” available from Ohshika Co., Ltd., in a coating amount of 60 g/m² (wet), thereby producing a wooden decorative plate.

### Reference Example 2

A particle board as a substrate having a thickness of 9 mm was bonded onto a back surface of the decorative material obtained in Example 2 through an adhesive layer formed on the particle board by applying thereto an urea-based synthetic resin adhesive “OHSHIKA RESIN” available from Ohshika Co., Ltd., in a coating amount of 60 g/m² (wet), thereby producing a wooden decorative plate.

### INDUSTRIAL APPLICABILITY

In accordance with the present invention, there can be obtained a decorative material which is totally excellent in surface properties including not only oil resistance, but also stain resistance, abrasion resistance and marring resistance. The decorative material is suitably used in various applications including decorative materials to be attached onto an outer surface of kitchen wares or cup boards, interior materials for buildings such as walls, surface materials for fittings such as doors, or furniture, etc.

1. A decorative material comprising a substrate, and at least one of a pattern layer and a colored layer, and a surface protective layer which are laminated on the substrate, wherein said substrate is constituted from an oil-resistant paper treated with a fluorine-based sizing agent which has a degree of oil resistance of 4 or more as measured by No. 41:2000 method prescribed in Japan TAPPI Paper and Pulp Testing Method, and said surface protective layer is obtained by crosslinking and curing an electron beam-curable resin composition.

2. A decorative material comprising a substrate, and a colored layer and a surface protective layer which are laminated on the substrate, wherein said colored layer is made of an acrylic resin composition, and said surface protective layer is obtained by crosslinking and curing an electron beam-curable resin composition.

3. The decorative material according to claim 2, wherein said substrate is constituted from an oil-resistant paper treated with a fluorine-based sizing agent which has a degree of oil resistance of 4 or more as measured by No. 41:2000 method prescribed in Japan TAPPI Paper and Pulp Testing Method.

4. The decorative material according to claim 2, wherein said acrylic resin is a two-part curable system containing a polyol component.

5. The decorative material according to claim 1, wherein an ink used in said at least one of the pattern layer and the colored layer contains titania.

6. The decorative material according to claim 1, further comprising a primer layer containing an acrylic resin which is formed between the at least one of the pattern layer and the colored layer, and the surface protective layer.

7. A decorative plate comprising a base plate and the decorative material as defined in claim 1 which is laminated on the base plate.

8. The decorative material according to claim 3, wherein said acrylic resin is a two-part curable system containing a polyol component.

9. The decorative material according to claim 2, wherein an ink used in said colored layer contains titania.

10. The decorative material according to claim 3, wherein an ink used in said colored layer contains titania.

11. The decorative material according to claim 2, further comprising a primer layer containing an acrylic resin which is formed between the colored layer and the surface protective layer.

12. The decorative material according to claim 3, further comprising a primer layer containing an acrylic resin which is formed between the colored layer and the surface protective layer.

13. A decorative plate comprising a base plate and the decorative material as defined in claim 2 which is laminated on the base plate.

14. A decorative plate comprising a base plate and the decorative material as defined in claim 3 which is laminated on the base plate.
